(19) United States
(12) Patent Application Publication
(10) Pub. No.: US 2013/0115703 A1
(43) Pub. Date: May 9, 2013

(54) DILUTION METHOD FOR DIGITAL MICROFLUIDIC BIOCHIPS

(71) Applicants: Bhargab B. Bhattacharya, Kolkata (IN); Sudip Roy, Kolkata (IN); Krishnendu Chakrabarty, Chapel Hill, NC (US)

(72) Inventors: Bhargab B. Bhattacharya, Kolkata (IN); Sudip Roy, Kolkata (IN); Krishnendu Chakrabarty, Chapel Hill, NC (US)

(73) Assignee: INDIAN STATISTICAL INSTITUTE, Kolkata, WB (IN)

(21) Appl. No.: 13/809,357

(22) PCT Filed: Nov. 13, 2010
(86) PCT No.: PCT/IB2010/002911

§ 371 Date: Jan. 9, 2013

(30) Foreign Application Priority Data
Jul. 15, 2010 (IN) 768/KOL/2010

(51) Int. Cl. G01N 1/38

(52) U.S. Cl. CPC G01N 1/38
USPC 436/55; 422/502

(57) ABSTRACT

Systems and methods are provided for producing fluids with desired concentration factors. According to one embodiment, a sequence of mix steps comprises mixing a resultant solution of a preceding mix step with one of the input solutions of the preceding mix step depending on a concentration factor of the resultant solution. If the concentration factor of the resultant solution is higher than the target concentration factor, then the resultant solution is mixed with the input solution having the lower concentration factor. If the concentration factor of the resultant solution is lower than the target concentration factor, then the resultant solution is mixed with the input solution having the higher concentration factor.

### CROSS-REFERENCE TO RELATED APPLICATION

The present application claims priority under 35 U.S.C. §119(d) to a corresponding patent application filed in India and having application number 768/KOL/2010, filed on Jul. 15, 2010, the entire contents of which are herein incorporated by reference.

### TECHNICAL FIELD

This application relates generally to a method for diluting a fluid sample to produce a desired concentration value.

### BACKGROUND

To meet the challenge of rising costs of laboratory diagnostics associated with prevalent diseases, such as cardiovascular disease, cancer, diabetes, HIV, etc., a new technology is emerging called “Lab-on-a-Chip (LOC).” LQC implements one or more biochemical laboratory protocols or assays on a small chip (e.g., one of a few square centimetres in area). Compared with traditional bench-top procedures, these biochips offer many advantages, namely low sample and reagent consumption, reduced likelihood of error due to minimal human intervention, and high throughput and high sensitivity.

One specific biochip, called a “digital microfluidic biochip”, is designed to integrate assay operations such as detection, as well as sample pre-treatment and sample preparation on one chip. Front-end diagnostic functions, such as dilution of a sample, can be carried out on-chip or by pre-processing during sample preparation outside the chip. Off-chip sample processing and sample preparation may pose a significant hindrance to the overall biochemical assay time, due to long lead times that may be required for laboratory processes. Therefore, it may be desired that for fast and high throughput applications, sample pre-processing steps, such as sample dilution, be automated on-chip, i.e., integrated and self-contained on the biochip itself.

One challenge with using microfluidic biochips for diluting samples is to use dilution schemes that both minimize waste and require a relatively small number of dilution steps to achieve the desired target concentration.

### SUMMARY

In accordance with one embodiment, a method for producing a fluid having a target concentration factor (CF) is provided and includes a plurality of sequential mix steps. In the first mix step, a sample/reagent fluid (first input) is mixed with a buffer solution (second input) to produce a resultant concentration. In each subsequent mix step, depending on the CF of the resultant fluid produced in the preceding mix step, at least part of that resultant fluid is mixed with one of the two inputs of the preceding mix step. The resultant fluid is mixed with the input having the higher of the two CFs when the resultant fluid has a CF smaller than the target CF. And the resultant fluid is mixed with the input having the lower of the two CFs when the resultant fluid has a CF greater than the target CF.

In another embodiment, software instructions for determining a sequence of mix steps used to produce a fluid having a target CF are provided and include a plurality of sequential calculation steps. In the first calculation step, a CF of a resultant fluid that would be produced if two input fluids were mixed together is calculated. In each subsequent calculation step, the resultant CF of the preceding calculation step is used. If the preceding resultant CF is less than the target CF, a new resultant CF is calculated from (i) the preceding resultant CF and (ii) the higher of the two preceding inputs. If the preceding resultant CF is greater than the target CF, then a new resultant CF is calculated from (i) the preceding resultant CF and (ii) the smaller of the two preceding inputs.

In a further embodiment, an environment for carrying out a sequence of calculation steps that may be used to produce a fluid having a target CF is provided. The environment may additionally or alternatively carry out the physical mixing steps themselves. In one implementation the environment is a microfluidic biochip.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a flow chart illustrating an example method for determining a sequence of mix steps and producing a fluid with a target concentration factor.

FIG. 2 is an example sequence of mix steps used to produce a fluid with a target concentration factor from a sample fluid having 100% concentration, and from a buffer fluid having 0% concentration.

FIG. 3 another example sequence of mix steps used to produce a fluid with another target concentration factor from a sample fluid having less than 100% concentration but greater than the target concentration factor, and from a buffer fluid having greater than 0% concentration, but less than the target concentration factor.

FIG. 4A is an example of an electrowetting-on-dielectric (EWOD) platform.

FIG. 4B is an example 1×3 array of EWOD platforms with separate droplets.

FIG. 4C is an example 1×3 array of EWOD platforms with 2 droplets mixed across the array.

FIG. 5 is the example sequence of mix steps of FIG. 2 with numerals (inside the circles) indicating the number of unit-volume droplets.

FIG. 6 is a block diagram illustrating an example computing device arranged for carrying out one or more methods described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

A dilution problem can be stated as: given a raw sample/reagent fluid (with 100% concentration) and a neutral buffer solution (with 0% concentration), determine a sequence of one-to-one (1:1) mixing and splitting steps for obtaining a desired concentration factor (CF) of the sample. CF is usually expressed as a percentage (e.g., 23%) or a fraction (e.g., 23/100) and can be thought of as a ratio of a volume of a raw sample to the volume of the final fluid after mixing with a buffer. An example reagent fluid with CF of 100% could be a volume of saturated salt water solution, while an example buffer solution with CF of 0% could be a volume of distilled water.

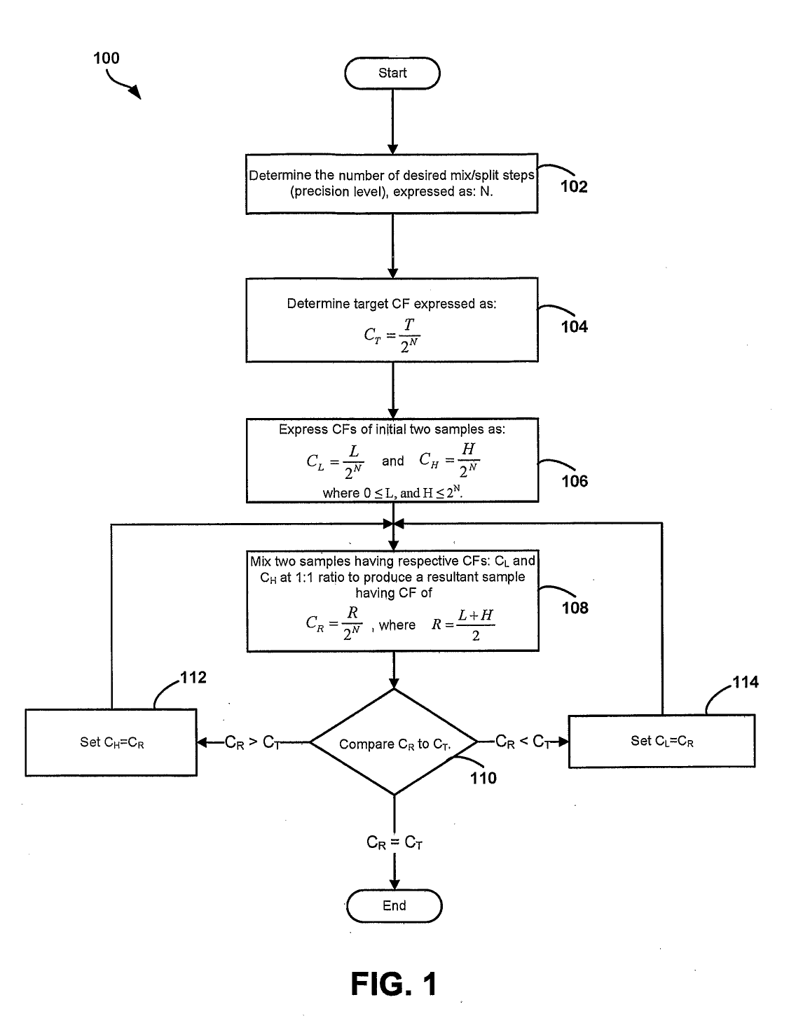

In accordance with one embodiment, a method for determining and carrying out a sequence of mix/split steps that result in a fluid with a desired target concentration factor is illustrated in the flow chart 100 in FIG. 1. The method for determining the sequence of mix/split steps is applicable to instances where a supplied reagent fluid (or raw sample) has a CF of 100% and a buffer solution has a CF of 0%, in addition to instances where the supplied reagent solution has a CF of less than 100% and the buffer solution has a CF of greater than 0%. In all cases, the concentration factor of the initial reagent solution can be expressed as C_{H}, the concentration factor of the buffer solution can be expressed as C_{L}, and the desired concentration factor (or target concentration factor) can be expressed as C_{T}, where 0%≦C_{L}<C_{T}<C_{H}≦100%.

The flow 100 begins at step 102 where the desired number of mix/split steps is chosen and expressed as an integer N. After N (or less) mix steps, a resultant solution is produced having the desired target concentration with an error limited to 1/2^{N}. Therefore, N can also be thought of as a precision level, since the larger N is, the more precise the target concentration can be.

Continuing at step 104, a target CF is expressed as a rational number with a denominator of 2^{N}. For example, in a case where N is chosen as 10, a desired target CF may be expressed as:

$${C}_{T} = \frac{T}{1024}$$

The numerator, T, may be chosen as any number depending on the application. A T=313, for example, may equate to a target CF of:

$${C}_{T} = \frac{313}{1024} \approx 30.6 \%$$

At step 106, the CFs of the initial two samples (e.g., a reagent solution and a buffer solution) are also expressed as rational numbers with denominators of 2^{N}. The initial sample with the lower CF is labeled as C_{L}, and the initial sample with the higher CF is labeled as C_{H}. For example, in a case where N is chosen as 10, and the lower input sample has a CF of 0% and the higher input sample has a CF of 100%, C_{L} may be expressed as:

$${C}_{L} = \frac{0}{1024}$$

and C_{H} may be expressed as:

$${C}_{H} = \frac{1024}{1024}$$

At step 108, samples with concentration factors of C_{L} and C_{H} are mixed in a 1:1 volume ratio. It should be understood that a 1:1 ratio may be any ratio in which both reactants have about equal volumes. Thus, a 1:1 ratio encompasses a 2:2, 3:3, or k:k ratio (where k is a whole number). The resultant mixture of step 108 has a CF that is an average of the C_{L} and C_{H} values, and may be expressed as:

$${C}_{R} = \frac{R}{{2}^{N}}$$

$$where \text{:}$$

$$R = \frac{L + H}{2}$$

For example, if a unit-volume of fluid with CF expressed as:

$${C}_{L} = \frac{0}{1024}$$

were mixed with a unit-volume fluid with CF expressed as:

$${C}_{H} = \frac{1024}{1024}$$

the resultant mixture would be 2 unit-volumes of fluid with a CF expressed as:

$${C}_{R} = \frac{\frac{0 + 1024}{2}}{1024} = \frac{512}{1024}$$

After mixing in step 108, the flow continues at step 110 where the CF of the resultant mixture is compared with the target CF. Naturally, if the CF of the resultant mixture is equal to C_{T} (or within an allowable error of about ±1/2^{N} of the C_{T}), then the flow ends. If the resultant CF is greater than the target CF, then the resultant mixture is mixed with the lower of the CFs used in the last mix step. This is illustrated in the flow by resetting the pointer C_{H} to be equal to C_{R} at step 112 and continuing the flow at mix step 108. If the resultant CF is less than the target CF, then the resultant mixture is mixed with the higher of the CFs used in the last step. This is illustrated in the flow by resetting the pointer C_{L} to be equal to C_{R} at step 114 and continuing the flow at mix step 108. In this manner, the resultant mixture of each mix step approaches the target CF.

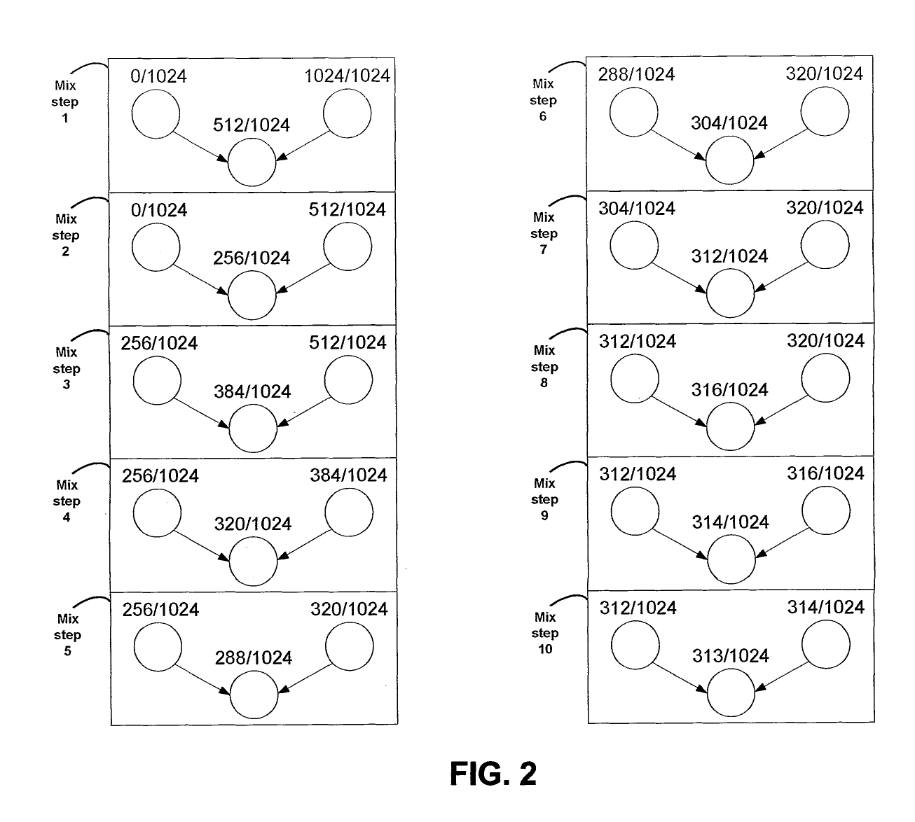

FIG. 2 illustrates an example sequence of mix steps according to the algorithm described in flow chart 100. In this example, 10 is chosen as the precision level, and therefore all the CFs are expressed with denominators of 2¹⁰=1024. The initial samples have CFs 0/1024 and 1024/1024, and a target CF is 313/1024 for this example. Thus, for mix step 1, C_{L}=0/1024, C_{H}=1024/1024, and C_{R}=512/1024. Since for each mix step the C_{L} and C_{H} are mixed at a 1:1 ratio, the numerator of the C_{R} can be calculated by taking the average of the numerators of the C_{L} and C_{H}. In mix step 1, for example, the C_{R} numerator, 512, is the average of the C_{L} numerator, 0, and the C_{H} numerator, 1024.

The resultant mixture of mix step 1 is larger than the target CF of 313/1024, therefore in the next mix step, the resultant of mix step 1 should be mixed with the smaller of the C_{L} and C_{H} used in mix step 1. This can be seen in mix step 2 as the 512/1024 mixture is mixed with the 0/1024 sample to produce a 256/1024 resultant. This 256/1024 resultant, having a smaller CF than the target 313/1024, is mixed with 512/1024 (the greater of the C_{L} and C_{H} used in mix step 2) in mix step 3. Mix step 3 thus produces a resultant having a CF of 384/1024.

The mix steps in FIG. 2 proceed in this manner, producing resultants having CFs of 320/1024 in mix step 4, 288/1024 in mix step 5, 304/1024 in mix step 6, 312/1024 in mix step 7, 316/1024 in mix step 8, 314/1024 in mix step 9, and finally the target CF, 313/1024 in mix step 10.

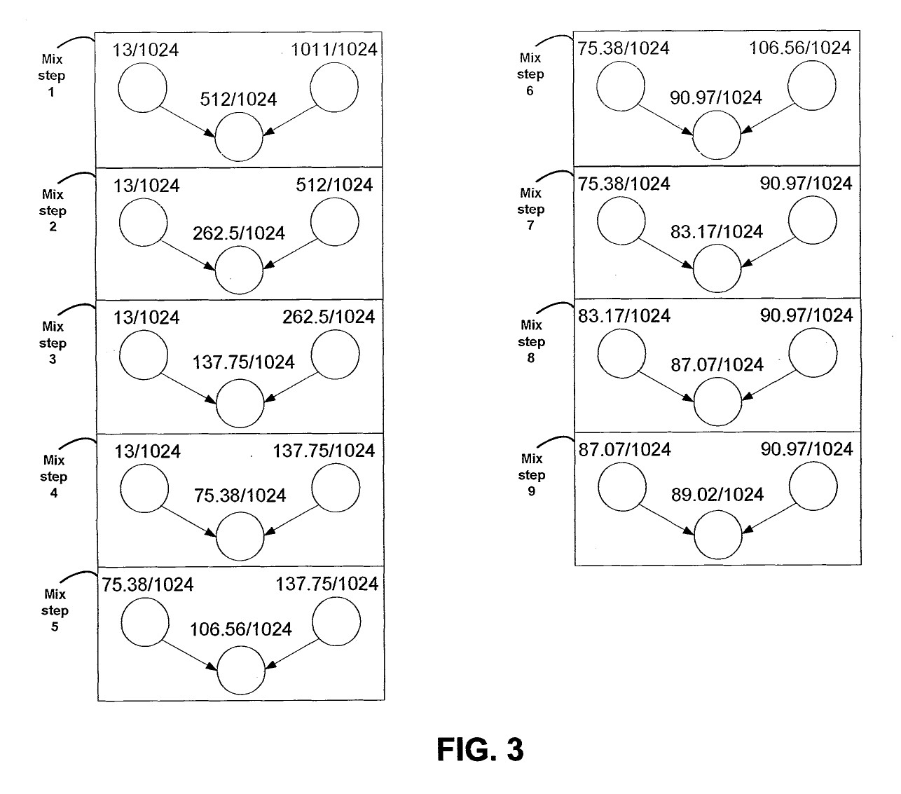

The algorithm described in flow chart 100 can be readily applied to cases where the initial samples have CFs other than 0/2^{N} and 2^{N}/2^{N}. FIG. 3 illustrates another such example sequence of mix steps according to the algorithm described in flow chart 100. In this example, 10 is again chosen as the precision level, and the target CF is expressed as 89/1024. The initial samples have CFs 13/1024 and 1011/1024. Following the steps in the algorithm described by flow chart 100, the mix steps produce resultants having CFs of 512/1024 in mix step 1, 262.5/1024 in mix step 2, 137.75/1024 in mix step 3, 75.38/1024 in mix step 4, 106.56/1024 in mix step 5, 90.97/1024 in mix step 6, 83.17/1024 in mix step 7, 87.07/1024 in mix step 8, and finally 89.02/1024 in mix step 9. A tenth mix step is unnecessary in this example since the resultant mixture of the ninth mix step has a CF of 89.02, which is within the acceptable error of ±1/2^{N}=±1/1024 from the target CF of 89/1024.

The disclosed algorithms and physical mix steps may take place in any setting that is appropriate for dilution of a sample fluid. For example, one application that the algorithms may be suited for includes a microfluidic biochip. Microfluidic biochips are designed to carry out biochemical laboratory protocols or assays on a single contained chip. For example, a single microfluidic biochip may be able to receive a small volume of sample/reagent fluid and a small volume of buffer solution, and contain all the necessary functionality within the chip to carry out each physical mixing and splitting step of a dilution algorithm.

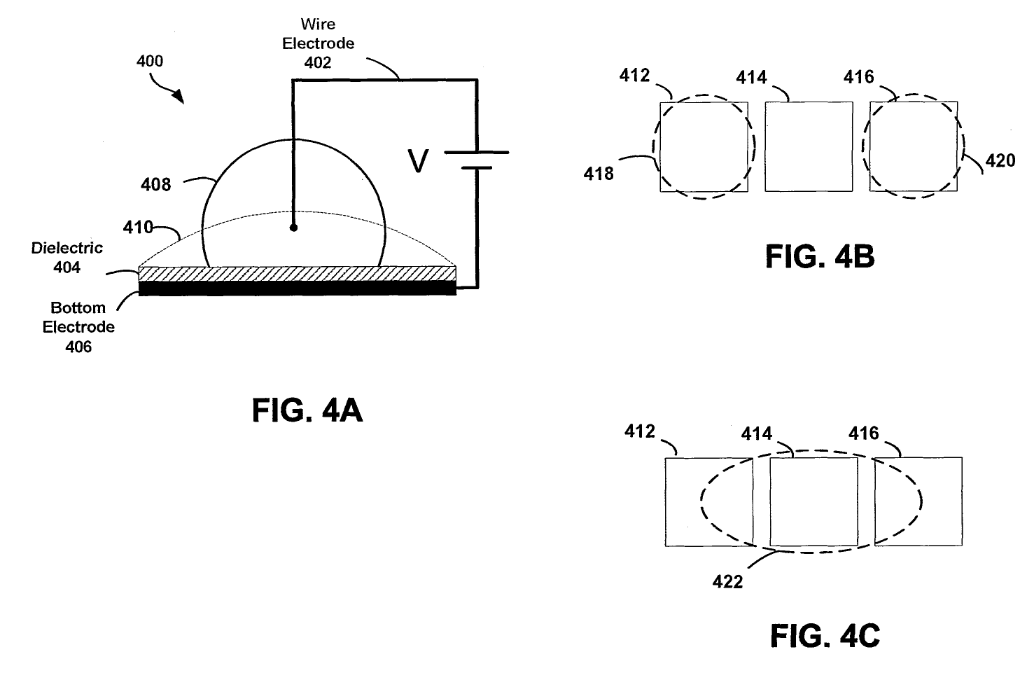

By way of example, such functionality may take the form of electrowetting-on-dielectric (EWOD) technology. EWOD technology relies on changing the wettability of liquids on a dielectric surface by varying the electric potential through the liquid. FIG. 4 illustrates a droplet 400 resting on an example EWOD surface or platform. A relatively low electric potential applied via a wire electrode 402 and a bottom electrode 406 may cause the droplet 400 to form a rounded shape illustrated by the solid curve 408. A relatively high electric potential applied via the wire electrode 402 and the bottom electrode 406 may cause the droplet 400 to flatten out in the manner illustrated by the dashed curve 410. Dielectric/electrode platforms, such as the one illustrated in FIG. 4, may be adjacently positioned, such that the application and de-application of electric potential to the platforms may cause a droplet to move from platform to platform. Further, the platforms may be positioned on the chip in such a way that the mixing of two or more droplets is carried out by causing the droplets to combine across one or more platforms.

A particular microfluidic biochip may include an array of platforms such as the 1×3 array of platforms illustrated in FIG. 4B and FIG. 4C. FIG. 4B illustrates platforms 412, 414, and 416, with platforms 412 and 416 holding respective droplets 418 and 420. An application of voltage to platform 414 and a de-application of voltage to platforms 412 and 416 may cause the droplets 418 and 420 to be attracted to platform 414. This combination of droplets 422 across platforms is illustrated in FIG. 4C. The combination droplet 422 has a volume of about twice the volume of individual droplets 418 or 420. A re-application of voltage to platforms 412 and 416 and a de-application of voltage to platform 414 can split the combination droplet 422 and result in the configuration illustrated in FIG. 4B.

Example droplet volumes that platforms might hold may be on the order of about 1-2 nL, though other volumes are possible as well, depending on the size of the platform. In addition to EWOD, other methods for carrying out mixing and splitting steps on a microfluidic biochip may exist as well, such as utilizing surface acoustic waves, or optoelectrowetting.

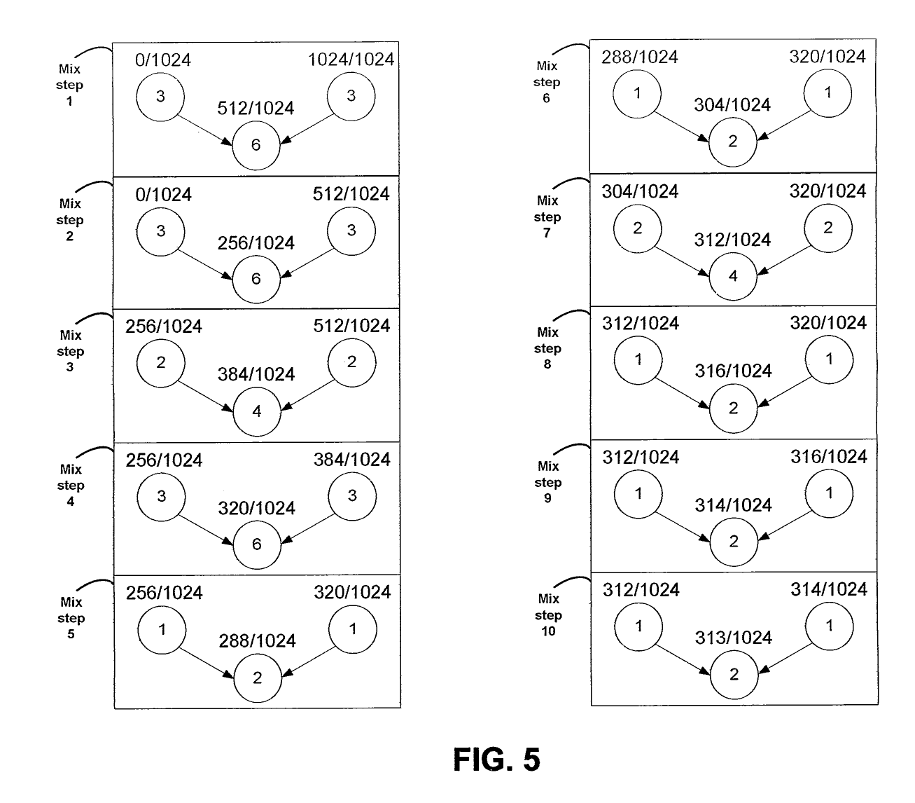

Biochips may be on the order of a few square centimeters in size and so a sequence of mix and split steps that result in a relatively small amount of wastage may be desired. One way, for example, to reduce the amount of wastage that results from a sequence of mix steps is, in each step, to mix together only the amount of solution that is needed in subsequent steps to produce the target CF. By way of example, FIG. 5 illustrates the sequence of mix and split steps of FIG. 2 with numerals (inside the circles) indicating the number of unit-volumes of each intermediate mixture used for producing 2 unit-volumes of the target CF in mix step 10. Depending on the application, other unit-volumes of the target CF may be desired as well (e.g., 4, 6, 8, etc.). Since each mix step in FIG. 5 is a 1:1 mix step, the solutions being mixed together are shown as having equal volumes, and therefore, the resultant mixture unit-volumes are multiples of 2.

A unit-volume may be the smallest volume of a solution desired to be (or possible to be) mixed in a mix step, for example. In some digital microfluidic biochips, for example, it may not be possible to control the volume of fluid contained on a single platform. Therefore, the smallest volume of fluid that can be mixed in a mix step may be a droplet from one platform mixed with a droplet from an adjacent platform. One unit-volume may thus refer to the volume of a droplet able to be contained on one platform of a DMF biochip. Biochips may have different platform sizes depending on the overall size of the biochip. Accordingly, different biochips may be associated with different unit-volumes, and may be chosen or designed as such depending on the application.

A method may be used to determine the number of unit-volumes of mixtures required in each mix step of a sequence of mix/split steps. In the example of FIG. 5, it has been determined that in mix step 10, 2 unit-volumes of target CF 313/1024 are desired. This therefore requires 1 unit-volume of 312/1024 to be mixed with 1 unit-volume of 314/1024. In mix step 9, 314/1024 is the resultant CF. To determine how many unit-volumes of 314/1024 are required to be produced in this step (with 2 unit-volumes being the minimum), it is determined how many unit-volumes of 314/1024 are needed in subsequent mixing steps. In this case, only 1 unit-volume of 314/1024 is needed in any subsequent mixing step (mix step 10, in this example), and so the minimum 2 unit-volumes of 314/1024 are to be produced in mix step 9. This thus requires 1 unit-volume of each of the reactants in mix step 9 (312/1024 and 316/1024).

The method continues by determining how many unit-volumes of 316/1024 are needed in mix step 8. Since only 1 unit-volume of 316/1024 is needed any in any subsequent mix step (mix step 9, in this example), the minimum 2 unit-volumes of 316/1024 are produced in mix step 8. This thus requires 1 unit-volume of each of the reactants in mix step 8 (312/1024 and 320/1024).

In mix step 7 of the example, it is determined that 4 unit-volumes of 312/1024 should be produced since 3 unit-volumes of 312/1024 are needed in subsequent mix steps (1 unit-volume in each of mix steps 8, 9, and 10). This thus requires 2 unit-volumes of each of the reactants in mix step 7 (304/1024 and 320/1024).

The method continues for each given mix step, thus determining the number of unit-volumes of the resultant solutions for given each mix step by determining the number of unit-volumes of the resultant solution used in subsequent mix steps. The number of unit-volumes for the reactants in each given mix step are determined by halving the number of unit-volume of the resultant solution (and rounding up). Carrying out the method for the remainder of mix steps in FIG. 5 has determined that 3 unit-volumes of initial CF 1024/1024 are used in mix step 1, 3 unit-volumes of initial CF 0/1024 are used in mix step 1, and 3 unit-volumes of initial CF 0/1024 are used in mix step 2. Thus, in this example, 9 unit-volumes of initial reactants are required. After the sequence of mix steps is carried out, 2 unit-volumes of target CF are produced. Thus, the example sequence of mix steps produces 9−2=7 unit-volumes of potential waste.

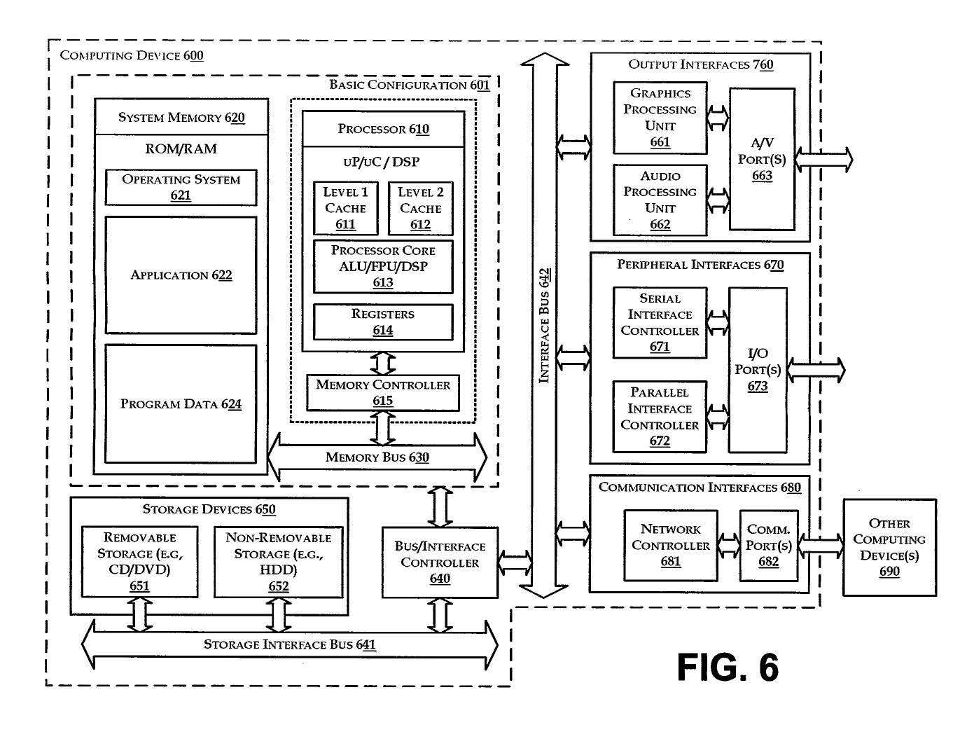

FIG. 6 is a block diagram illustrating an example computing device 600 that may be associated with a biochip. All or part of computing device 600 may be embedded within a biochip, or a biochip may be designed to couple with all or part of computing device 600 outside of the biochip (e.g., to receive instructions).

In a very basic configuration 601, computing device 600 typically includes one or more processors 610 and system memory 620. A memory bus 630 can be used for communicating between the processor 610 and the system memory 620.

Depending on the desired configuration, processor 610 can be of any type including but not limited to a microprocessor (g), a microcontroller (μC), a digital signal processor (DSP), or any combination thereof. Processor 610 can include one more levels of caching, such as a level one cache 611 and a level two cache 612, a processor core 613, and registers 614. The processor core 613 can include an arithmetic logic unit (ALU), a floating point unit (FPU), a digital signal processing core (DSP Core), or any combination thereof. A memory controller 615 can also be used with the processor 610, or in some implementations the memory controller 615 can be an internal part of the processor 610.

Depending on the desired configuration, the system memory 620 can be of any type including but not limited to volatile memory (such as RAM), non-volatile memory (such as ROM, flash memory, etc.) or any combination thereof. System memory 620 typically includes an operating system 621, one or more applications 622, and program data 624.

Application 622 may include all or part of the disclosed algorithms. For example, application 622 may receive as an input the desired target concentration factor, the desired number of unit-volume of the target concentration factor, the concentration factors of the initial reagent and buffer solutions, and the precision level (i.e., the value of N). The application 622 may responsively determine the appropriate mix/split steps to achieve the desired volume of the target concentration factor. Further, application 622 may include instructions for carrying out the determined mix/split steps as well. For example, in an EWOD device associated with computing device 600, the application 622 may determine instructions for operating an array of EWOD platforms for carrying out the determined mix/split steps. Such instructions may take the form of a bit pattern/bit stream, called the actuation sequence for the addressable array of electrodes.

Computing device 600 can have additional features or functionality, and additional interfaces to facilitate communications between the basic configuration 601 and any required devices and interfaces. For example, a bus/interface controller 640 can be used to facilitate communications between the basic configuration 601 and one or more data storage devices 650 via a storage interface bus 641. The data storage devices 650 can be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of device 600.

Computing device 600 can also include an interface bus 642 for facilitating communication from various interface devices (e.g., output interfaces, peripheral interfaces, and communication interfaces) to the basic configuration 601 via the bus/interface controller 640. Example output interfaces 660 include a graphics processing unit 661 and an audio processing unit 662, which can be configured to communicate to various external devices such as a display or speakers via one or more AN ports 663. Example peripheral interfaces 660 include a serial interface controller 671 or a parallel interface controller 672, which can be configured to communicate with external devices such as input devices (e.g., keyboard, mouse, pen, voice input device, touch input device, etc.) or other peripheral devices (e.g., printer, scanner, etc.) via one or more I/O ports 673. An example communication interface 680 includes a network controller 681, which can be arranged to facilitate communications with one or more other computing devices 690 over a network communication via one or more communication ports 682. The Communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media (or medium) as used herein can include both storage media and communication media.

Computing device 600 can be implemented as a portion of a microfluidic biochip. Computing device 600 can also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or materials, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for producing a fluid having a target concentration factor, the method comprising:
determining a target concentration factor for an end resultant fluid sample;
mixing a first fluid sample having a first concentration factor with a second fluid sample having a second concentration factor to produce a first resultant fluid sample having a third concentration factor; and
one or more subsequent mixing steps, in which each given subsequent mixing step comprises:
mixing two input fluid samples having different concentration factors to produce a given resultant fluid sample;
comparing the concentration factor of the given resultant fluid sample produced in an immediately preceding mixing step with the target concentration factor; and
based on the comparison:
mixing at least part of the given resultant fluid sample as a first input fluid sample with a second input fluid sample that has a concentration factor equal to the smaller of the concentration factors of the two input fluid samples used in the immediately preceding mixing step if the concentration factor of the given resultant fluid sample is larger than the target concentration factor; and
mixing at least part of the given resultant fluid sample as a first input fluid sample with a second input fluid sample that has a concentration factor equal to the larger of the concentration factors of the two input fluid samples used in the immediately preceding mixing step if the concentration factor of the given resultant fluid sample is smaller than the target concentration factor.

2. The method of claim 1, wherein the first concentration factor is 0%, and wherein the second concentration factor is 100%.

3. The method of claim 1, wherein the first concentration factor is greater than 0% and less than 100%, and wherein the second concentration factor is greater than 0% and less than 100%.

4. The method of claim 1, wherein a volume of the first fluid sample and a volume of the second fluid sample are substantially equal, and wherein for each given mixing step of the one or more subsequent mixing steps, volumes of the two input fluid samples are substantially equal.

5. The method of claim 1, wherein the resultant fluid sample of a last mixing step of the one or more subsequent mixing steps has a concentration factor equal to the target concentration factor.

6. The method of claim 1, wherein the target concentration factor is expressed as a rational number with a denominator of 2^{N}, where N is an integer, and wherein the resultant fluid sample of a last mixing step of the one or more subsequent mixing steps has a concentration factor equal to the target concentration factor within an error of about +/−1/2^{N}.

7. The method of claim 6, wherein a total number of mixing steps is no more than N.

8. The method of claim 1, wherein at least one of the mixing steps takes place on a microfluidic biochip.

9. The method of claim 1, wherein for each given mixing step of the one or more subsequent mixing steps, the other of the two input fluid samples is at least part of a resultant fluid sample that was produced in one of the preceding mixing steps.

10. (canceled)

11. A physcial computer readable medium having computer executable instructions stored thereon, which when executed by a computing device, causes the computing device to carry out a sequence of operations, the operations comprising:
calculating a value associated with a target concentration factor (CF) of a target resultant fluid;
calculating a value associated with a CF of a resultant fluid that would be produced upon mixture of a first input fluid having a first input CF with a second input fluid having a second input CF; and
one or more subsequent calculation steps, in which each given subsequent calculation step comprises:
choosing two input CFs and calculating a resultant value associated with a CF of a resultant fluid that would be produced when respective fluids having the two input CFs are mixed,
comparing the CF of the resultant fluid that would be produced in an immediately preceding mixing step with the target CF; and
based on the comparison:
choosing the resultant CF and the larger of the two input CFs used in the immediately preceding calculation step as the two input CFs for the subsequent step when a resultant value calculated in the immediately preceding calculation step is smaller than the target CF; and
choosing the resultant CF and the smaller of the two input CFs used in the immediately preceding calculation step as the two input CFs for the subsequent step when a resultant value calculated in the immediately preceding calculation step is larger than the target CF.

12. The computer readable medium of claim 11, wherein the target CF is expressed as a rational number with a denominator of 2^{N}, where N is an integer value, and wherein the CF of a resultant fluid calculated in the last calculation step of the one or more subsequent calculation steps is equal to the target CF within an error of about +/−1/2^{N}.

13. The computer readable medium of claim 12, wherein the CF of the resultant fluid calculated in a last calculation step of the one or more subsequent calculation steps is substantially equal to the target CF.

14. The computer readable medium of claim 12, wherein a total number of calculation steps is no more than N.

15. The method of claim 11, wherein the first input CF is 0%, and wherein the second input CF is 100%.

16. The method of claim 11, wherein the first input CF is greater than 0% and less than 100%, and wherein the second input CF is greater than 0% and less than 100%.

17. (canceled)

18. A system comprising:
a computing device;
memory storage coupled to the computing device;
software instructions stored in the memory storage, which when executed by the computing device, cause the computing device to determine a sequence of mixing steps comprising:
determining a target concentration factor for an end resultant fluid sample;
mixing a first fluid sample having a first concentration factor with a second fluid sample having a second concentration factor to produce a first resultant fluid sample having a third concentration factor; and
one or more subsequent mixing steps, in which each given subsequent mixing step comprises:
mixing two input fluid samples having different concentration factors to produce a given resultant fluid sample;
comparing the concentration factor of the given resultant fluid sample produced in an immediately preceding mixing step with the target concentration factor; and
based on the comparison:
mixing at least part of the given resultant fluid sample as a first input fluid sample with a second input fluid sample that has a concentration factor equal to the smaller of the concentration factors of the two input fluid samples used in the immediately preceding mixing step if the concentration factor of the given resultant fluid sample is larger than the target concentration factor; and
mixing at least part of the given resultant fluid sample as a first input fluid sample with a second input fluid sample that has a concentration factor equal to the larger of the concentration factors of the two input fluid samples used in the immediately preceding mixing step if the concentration factor of the given resultant fluid sample is smaller than the target concentration factor;
a microfluidic device for carrying out the sequence of determined mixing steps.

19. The system of claim 18, wherein the microfluidic device comprises:
a plurality of electrowetting-on-dielectric (EWOD) platforms; and
a controller coupled to the plurality of EWOD platforms and configured to control the plurality of EWOD platforms to carry out mixing and splitting steps according to the determined sequence of mixing and splitting steps.

20. The system of claim 18, wherein the target concentration factor (CF) is expressed as a rational number with a denominator of 2^{N}, where N is an integer value, and wherein the CF of a resultant fluid produced in the last mixing step of the one or more subsequent mixing steps is equal to the target CF within an error of about +/−1/2^{N}.
